(19) United States
(12) Patent Application Publication
(10) Pub. No.: US 2017/0352054 A1
(43) Pub. Date: Dec. 7, 2017

(54) DELIVERING ELECTRONICALLY GENERATED OFFERS

(71) Applicant: DIGITAL ALCHEMY (AUSTRALIA) PTY LTD, Sydney, New South Wales (AU)

(72) Inventors: Wenjin Ma, Homebush West (AU); Ming Kit Lee, Lindfield (AU)

(21) Appl. No.: 15/523,735

(22) PCT Filed: Nov. 13, 2015
(86) PCT No.: PCT/AU2015/000689

§ 371 Date: May 2, 2017

(30) Foreign Application Priority Data
Nov. 13, 2014 (AU) 2014904566
Nov. 14, 2014 (AU) 2014904577

(51) Int. Cl. G06Q 30/02

(52) U.S. Cl. CPC G06Q 30/0254; G06Q 30/0255

(57) ABSTRACT

Techniques are disclosed for delivering electronically generated offers to particular users, and more particularly, for obtaining and receiving data of particular types from specified sources to provide output that is generated from a decisioned library. The techniques include retrieving a product score that comprises a probability that a first user will obtain a first product, obtaining a behavioral value, and generating a score of a behavior value. The score of the first product behavioral value is then mathematically combined with a similarly derived second score of a product behavioral value to determine whether to generate and deliver an offer to the first user.

### FIELD OF THE INVENTION

Disclosed are methods and systems for delivering electronically generated offers to particular customers, and more particularly, for obtaining and receiving data of particular types or forms and from specified sources, and processing the data to provide as output generated from a decisioned library.

This is the U.S. National Phase of International Application PCT/AU2015/000689, filed Nov. 13, 2015, and which claims priority from Australian Provisional Patent Application No. 2014904566 filed on Nov. 13, 2014, and Australian Provisional Patent Application No. 2014904577 filed on Nov. 14, 2014, the contents of each of which are incorporated herein in their entirety by reference.

### BACKGROUND ART

Businesses are increasingly turning to marketing via electronically generated advertisements and offers over traditional forms of marketing such as print, radio and television. Electronically generated advertisements and offers are delivered to customers and potential customers via email, SMS, impressions during web browsing, and the like.

Offers provided by vendors have generally dictated the marketing process. That is, a vendor has an offer or a set of offers, and then will select a set of customers to whom to market the offer. The outcome of this approach is often poor take-up results.

The way direct marketing campaigns are typically built is as follows:

Step 1—a customer selection is made for each campaign. The customers are selected from customer segmented groups where particular customers are grouped together based on certain attributes. For example, 30-40 year olds living in NSW who do not have a credit card with ABC Bank and have just made a withdrawal using their debit card.

Step 2—attach an “offer” to the campaign (e.g. a credit card from ABC Bank with annual fee waived for first year). Note that a different offer (e.g. a Personal Loan from ABC Bank) could be attached to the same customer selection by first creating a different campaign and then attaching this offer to that campaign.

Step 3—attach a “channel” (or channels) to the campaign. This is the communication medium that is used to deliver the offer to the selected customer, e.g. direct mail or email.

Step 4—determine how often the campaign is run, e.g. once-off, once a day for ‘n’ days, once a week for ‘n’ weeks.

The above four steps are referred to as a “Campaign Optimization” approach. At any point in time, for example, on a daily basis, there will be a number of direct marketing campaigns that an organisation will execute (not necessarily all that are available based on the campaign run frequency (defined in Step 4)). A customer may belong in more than one campaign (Step 1). Due to customer “contact rules” that have been defined, it is often the practice, at least in Australia, for a customer to only be contacted by one of these campaigns. Therefore, currently there is a product to determine which offer a customer receives for campaigns that run on a specific day.

IBM Optimise™ (previously Unica Optimise™) is one such product. It uses a deterministic rules based logic based on inputs provided to an “Optimisation Engine”. Example of inputs include propensity scores or campaign attributes such as “Campaign Type” (e.g. On-boarding, Cross-Sell or Up-Sell) or “Target Method” (meaning method used to create the customer selection criteria (e.g. Propensity) Model, Trigger (customer action/behaviours) or broad-based) or “Business Unit” (e.g. Credit Cards vs. Personal Loans). Other than the fact that the optimisation logic being rules based, which is relatively simple, it also only arbitrates between the campaigns that have been scheduled to run on that specific day which is quite limiting, and therefore often results in poor take-up results.

It is against this background that this invention has been developed.

### SUMMARY OF THE INVENTION

Embodiments of the invention seek to overcome, or at least ameliorate, one or more of the deficiencies of the prior art mentioned above, or to provide the consumer with a useful or commercial choice.

Advantages of embodiments of the invention will become apparent from the following description, taken in connection with the accompanying drawings, wherein, by way of illustration and example, a preferred embodiment of the invention is disclosed.

According to a first broad aspect of the present invention, there is provided a method of optimising a Next Best Offer (NBO) for a customer and for generating an offer to a customer, the method comprising:

retrieving a product score that comprises a probability that a first customer will purchase a first product;

obtaining a purchase behavioural value, and generating a score of a purchase behavioural value which comprises a calibrated score determined by characterisation of data collected of the purchasing conduct of the first customer;

processing the product score with the score of the purchase behavioural value to generate a first product behavioural score;

processing the first product behavioural score with a similarly derived second product behavioural score to determine whether to electronically generate to the first customer a first offer or a second offer as a NBO, and wherein the second product behavioural score can relate to a product in a completely different product category to the first product; and

generating at least one of the first offer and the second offer for delivery to the first customer.

According to a second broad aspect of the present invention, there is provided a method of optimising a Next Best Offer (NBO) for a customer and for generating an offer to a customer, the method comprising:

receiving a plurality of offers stored in an offer library populated with offers of a plurality of offer vendors;

wherein the offers are associated with product scores, the product scores comprising probabilities that a particular customer will purchase a first product;

obtaining a purchase behavioural value and generating a score of the purchase behavioural value relating to the particular customer, the score of the purchase behavioural value comprising a calibrated score determined by characterisation of data collected of and/or associated with the purchasing conduct of the particular customer;

processing the product score with the score of the purchase behavioural value to generate a first product behavioural score as a result of the processing of the product score with the score of the purchase behavioural value;

processing the first product behavioural score with a similarly derived second product behavioural score to determine whether to generate to the first customer a first offer or a second offer as a NBO, and wherein the second product behavioural score can relate to a product in a completely different product category to the first product; and

generating at least one of the first offer and the second offer for delivery to the first customer.

In an embodiment, the method further comprises obtaining a purchase behavioural value, and generating a score of a purchase behavioural value of a second customer, wherein the characterisation of data of the first customer is distinguishable from the characterisation data of the second customer.

In another embodiment, delivery is electronic delivery via at least one of an email, a website, a mobile application, a text message, and a voice message.

In a further embodiment, a delivery channel is selected from a branch, a call centre, and a point of sale.

In an embodiment, a delivery method is to any customer, in a batch and in real-time.

In another embodiment, the method further comprises processing at least one of the first offer and the second offer for delivery within a specified time frame.

In a further embodiment, the method comprises, prior to generating the second offer to the first customer, determining whether generating either the first offer or the second offer violates a rule associated with at least one of them to the first customer.

In an embodiment, the purchasing conduct of the first customer relates to discount purchasing tendencies.

In another embodiment, the purchasing conduct of the first customer relates to name brand purchasing tendencies.

In a further embodiment, the purchasing conduct of the first customer relates to geographic origin of products purchasing tendencies.

In an embodiment, the purchasing conduct of the first customer relates to quality of products purchasing tendencies.

In another embodiment, the purchasing conduct of the first customer relates to frequency of purchasing tendencies.

In a further embodiment, the purchasing conduct of the first customer relates to response to advertising purchasing tendencies.

In an embodiment, the first product behavioural score and the second product behavioural score are weighted.

In another embodiment, the purchasing conduct includes the monetary value of historical purchases.

In a further embodiment, the first customer is one of an individual customer and a member of customer segment.

In an embodiment, the score of the purchase behavioural value is dynamically calibrated.

According to a third broad aspect of the present invention, there is provided a method of a device application for optimising a Next Best Offer (NBO) for a customer, the method comprising:

displaying a first received offer on a display of the device;

receiving a first input representing an action relating to the first offer;

generating a save process to generate a saved offer in accordance with the first input;

replacing the first electronic offer on the display by a second received offer on the display in accordance with the first input;

displaying the second received offer on the display;

receiving a second input representing an action relating to the second offer;

if the second input comprises saving the offer, then generating a save process to generate a saved offer in accordance with the second input; and

transmitting data related to one or more the saved offers;

wherein the application is in communication with data processing, the method further comprising:

receiving one or more saved offer(s) as input;

obtaining a score of the purchase behavioural value comprising a dynamically calibrated score which is determined by characterisation of data collected related to one or more received saved offers to determine whether to electronically generate a third offer as a NBO, and wherein the score of the purchase behavioural value can relate to saved offers in completely different product categories; and

generating a third offer for display in accordance with the one or more received saved offers.

In a further embodiment, delivery of the first and second offers comprises retrieving a product score that comprises a probability that a customer will purchase a first and a second product.

In an embodiment, the method further comprises:

processing the purchase behavioural value to generate a score of the purchase behaviour value; and

processing the product score with the score of the purchase behavioural value to generate a product behavioural score to determine the third offer for delivery for display.

In another embodiment, the method further comprises generating the third offer for display in accordance with the purchase behavioural score.

In a further embodiment, the method comprises, if the first input is ignoring the offer or if the second input is ignoring the offer, then replacing the first or second offer on the display by another received offer on the display.

In an embodiment, the method further comprises processing at least one of the first offer and the second offer for delivery within a specified time frame.

In another embodiment, a delivery method is to any customer, in a batch and in real-time.

In a further embodiment, the device comprises a mobile device.

According to another broad aspect of the present invention, there is provided a system, or a device, for optimising a Next Best Offer (NBO) for a customer and for generating an offer to a customer, the system or device comprising a controller and storage storing electronic program instructions for controlling the controller, wherein the controller is operable, under control of the electronic program instructions, to:

receive a product score that comprises a probability that a first customer will purchase a first product;

obtain a purchase behavioural value, and generate a score of a purchase behavioural value which comprises a calibrated score determined by characterisation of data collected of and/or associated with the purchasing conduct of the first customer;

process the product score with the score of the purchase behavioural value to generate a first product behavioural score;

process the first product behavioural score with a similarly derived second product behavioural score to determine whether to electronically generate to the first customer a first offer or a second offer as a NBO, and wherein the second product behavioural score can relate to a product in a completely different product category to the first product; and

generate at least one of the first offer and the second offer for delivery to the first customer.

According to an additional broad aspect of the present invention, there is provided a system, or a device, for optimising a Next Best Offer (NBO) for a customer and for generating an offer to a customer, the system or device comprising a controller and storage storing electronic program instructions for controlling the controller, wherein the controller is operable, under control of the electronic program instructions, to:

receive a plurality of offers stored in an offer library populated with offers of a plurality of offer vendors;

wherein the offers are associated with product scores, the product scores comprising probabilities that a particular customer will purchase a first product;

obtain a purchase behavioural value and generate a score of the purchase behavioural value relating to the particular customer, the score of the purchase behavioural value comprising a calibrated score determined by characterisation of data collected of and/or associated with the purchasing conduct of the particular customer;

process the product score with the score of the purchase behavioural value to generate a first product behavioural score as a result of the processing of the product score with the score of the purchase behavioural value;

process the first product behavioural score with a similarly derived second product behavioural score to determine whether to generate to the first customer a first offer or a second offer as a NBO, and wherein the second product behavioural score can relate to a product in a completely different product category to the first product; and

generate at least one of the first offer and the second offer for delivery to the first customer.

According to another broad aspect of the present invention, there is provided a computer-readable storage medium on which is stored instructions that, when executed by a computing means, causes the computing means to perform any embodiment of a method in accordance with the first, second, or third broad aspects of the present invention as herein described.

According to a broad aspect of the present invention, there is provided a computing means programmed to carry out any embodiment of a method in accordance with the first, second, or third broad aspects of the present invention as herein described.

According to another broad aspect of the present invention, there is provided a data signal including at least one instruction being capable of being received and interpreted by a computing system, wherein the instruction implements any embodiment of a method in accordance with the first, second, or third broad aspects of the present invention as herein described.

According to a further broad aspect of the present invention, there is provided a method for generating an offer to a customer, comprising use of a system, or a device, according to any embodiment of a broad aspect of the present invention as herein described.

Embodiments of the present invention provide improved take-up results of marketing campaigns by de-coupling the customer selection from an offer and (communication) channel among other beneficial features described herein. In this way a more pure, more optimal allocation of offers to customers can be based on a library of available offers in market (provided by one or more organisations), i.e. not limited to what offers have been attached to campaigns on a given day, and providing a solution to the “optimisation” problem.

In this way, electronically generated advertisements and offers are delivered to customers and potential customers via email, SMS, impressions during web browsing, and the like in accordance with embodiments of the systems and methods of aspects of the invention described herein. Embodiments of the systems and methods of aspects of the invention may provide direct offers with direct mail and call centres. The present description is not intended to limit delivery methods of offers.

In embodiments of the invention, there are a plurality of types of data, and preferably three phases, which may be referred to as Phase 1, Phase 2 and Phase 3 types of data which may be applicable under different circumstances. As will be described in further detail below, Phase 1 data is customer data which can be provided by a customer or someone associated with the customer. Phase 2 data is transactional data that is collected in accordance with transactions made by the customer. Phase 3 data is behavioural data which is obtained by examining customer specific purchasing habits. For example, in Phase 3, purchasing tendencies are examined such as discount purchasing tendencies, product type purchasing tendencies, award purchasing tendencies, frequency of purchasing specific types of products tendencies, purchasing price tendencies, name brand purchasing tendencies, geographic origin of products purchasing tendencies, and the like. The processes in which the types of data is used is discussed in detail below. The approach of embodiments includes scoring individuals wherein in the prior art, segmentation provides homogenous customers partitioning customer into groups of look-alikes. As mentioned, in the prior art, the offer allocation starts with the offers. Product association can be customer specific in embodiments of the invention.

In embodiments of the invention, the following steps may be included to ultimately generate an electronic offer to one or more customers:

1. Customer selection made independently from other processes. This can be uniquely characterised by and comprise one or both of:
(a) customer attributes such as demographics; and
(b) a change in a state of the customer e.g. a decline in transaction activity.
In embodiments, this is used to provide context to the conversation.

2. “Offer library” to be managed independently from other processes; in embodiments, it will house all or at least some available offers provided by the organisation that could be given to a customer. This can be uniquely characterised by Offer Attributes, which can be broadly categorised into three Offer Attribute Types, as follows:
(a) offer Constraints e.g. eligibility criteria (age>18);
(b) offer Value Attributes e.g. discount level, price; and
(c) product Attributes e.g. frequency/repeatability of product, product category that the specific product belongs to, purchase cycle of product, size of product (e.g. if shampoo: 500 ml vs. 1 L).

3. In embodiments, a Next Best Offer (NBO) Optimisation Engine is operable to assign/calculate a “score” for each customer (Step 1) and offer (Step 2) combination which is used to determine the optimal outcome (offer) for each customer. This process is described in further detail with respect to Phase 1 and Phase 2 below.
In embodiments, the NBO Engine would consider not only the most appropriate product but how a customer purchases things (their “purchase behaviour”) as a weighted score, which is described in further detail with respect to Phase 3 below.
It should be noted that, in embodiments of the invention, there may be additional Global Constraints (i.e. not specific to an Offer) that the NBO Optimisation Engine will also apply to ensure particularly ‘eligible’ customers are ultimately selected.

4. Finally, in embodiments, additional decisions are made to determine an optimal channel via which to communicate the offer to the customer. The optimal channel can be determined in different ways. However, in embodiments of the invention, the electronic delivery mechanism or path is less of an issue than the appropriate customer offering for a particular customer.

There are a number of applications of embodiments of the present invention providing solutions to the optimisation problem which can be used to enhance the customer experience and their value to an organisation (for example, if an organisation can demonstrate that they can meet a customer's needs and wants better, this is likely to result in greater customer retention, loyalty and spend).

In a different manner than the “campaign optimisation” example (described above), if the customer selection is a given, i.e. it is supplied through one means or another (Phase 1, Phase 2 and/or Phase 3), the problem to be solved may be the identification of the most optimal offer or set of offers for a customer. In this way, an appropriate customer offering can result in improved take-up results.

Herein is described the details behind an embodiment of the NBO Optimisation Engine itself and the supporting processes in the context of a product provided under the trade mark Beepit™ and an extension to the referenced “Beepit™ Phase 2” which further describes Phase 3. While the Beepit™ product is a useful model in the present description in no way is the description of the Beepit™ product meant as a limitation to the scope of the description. Interchangeable terms used herein are Beepie=character, Member=individual=user and Occasion=event.

Aspects of the invention accordingly disclosed are methods and systems for carrying out methods for generating an offer to a customer, including retrieving a product score that comprises a probability that a first customer will purchase a first product, obtaining a purchase behavioural value, and generating a score of a purchase behavioural value which comprises a calibrated score determined by characterisation of data collected of the purchasing conduct of the first customer, processing the product score with the score of the purchase behavioural value to generate a first product behavioural score, processing, which may be comparing, the first product behavioural score with a similarly derived second product behavioural score to determine whether to electronically generate to the first customer a first offer or a second offer, and generating at least one of the first offer and the second offer for delivery to the first customer. The disclosed methods and systems for carrying out the method can include receiving a plurality of offers stored in an offer library populated with offers of a plurality of offer vendors wherein the offers are associated with product scores.

An aspect of the invention also disclosed is obtaining a purchase behavioural value, and generating a score of a purchase behavioural value of a second customer, wherein the characterisation of data of the first customer is distinguishable from the characterisation data of the second customer. Moreover, disclosed is that the delivery is electronic delivery via at least one of email, a website, a mobile application, a text message and a voice message and the delivery channel is selected from a branch, call center, and point of sale. Also disclosed is that a delivery method can be to any customer, in a batch and in real-time. Further disclosed is that at least one of the first offer and the second offer for delivery within a specified time frame, and that prior to generating an offer to a customer, the method can include determining whether generating either the first offer or the second offer violates a rule associated with at least one of them to the first customer. The score of the purchase behavioural value can be dynamically calibrated.

In embodiments, the purchasing conduct of the first customer can relate to discount purchasing tendencies, to name brand purchasing tendencies, to geographic origin of products purchasing tendencies, to quality of products purchasing tendencies, to frequency of purchasing tendencies, to response to advertising purchasing tendencies, as well as other contemplated tendencies. Purchasing conduct can include the monetary value of historical purchases.

In embodiments, the disclosed methods and systems for carrying out the method can include that the first product behavioural score and the second product behavioural score are weighted. A customer may be one of an individual customer and a member of customer segment.

Aspects of the invention also disclosed are methods and systems for carrying out the methods of displaying a first received offer on a display screen of the mobile device, receiving a first input representing an action relating to the first offer from the display screen, generating a save process to generate a saved offer in accordance with the first input, replacing the first electronic offer on the display screen by a second received offer on the display screen in accordance with the first input, displaying the second received offer on the display screen, if the second input is saving the offer, then receiving a second input representing an action relating to the second offer from the display screen, generating a save process to generate a saved offer in accordance with the second input and transmitting data related to one or more the saved offers. Also, disclosed is generating a third offer for display in accordance with the one or more received saved offers.

Also disclosed is wherein the application is in communication with data processing, receiving one or more saved offer as input and obtaining a score of the purchase behavioural value comprising a dynamically calibrated score which is determined by characterisation of data collected related to one or more received saved offers. Also disclosed is that delivery of the first and second offers comprises retrieving a product score that comprises a probability that a customer will purchase a first and a second product. Further disclosed is processing the purchase behavioural value to generate a score of the purchase behaviour value, processing the product score with the score of the purchase behavioural value to generate a product behavioural score to determine the third offer for delivery for display. Moreover, disclosed is generating a third offer for display in accordance with the purchase behavioural score. Also disclosed is where if the first input is ignoring the offer or if the second input is ignoring the offer, then replacing the first or second offer on the display screen by another received offer on the display screen.

### BRIEF DESCRIPTION OF THE DRAWINGS

Notwithstanding any other embodiments that may fall within the scope of the present invention, an embodiment of the present invention will now be described, by way of example only, with reference to the accompanying Figures, in which:

FIG. 1 depicts an embodiment of a system having a mobile device application, as an example, in which customer behaviours in the form of customer preference data is saved by a user and processed to provide offers in accordance with the customer behaviours in accordance with aspects of the present invention;

FIG. 2 depicts a schematic diagram of an embodiment of a device in accordance with an aspect of the present invention;

FIG. 3 depicts data of Phase 1 and Phase 2 ultimately resulting in a product score and in the data of Phase 3 resulting in a score of purchase behaviour value which are processed to generate a product behavioural score and thus decisioned offer to a particular customer or customers; and

FIG. 4 depicts data types that can make up Phase 1 data, Phase 2 data and Phase 3 data as well as the ability to detect a change in customer data.

### DETAILED DESCRIPTION OF EMBODIMENT(S)

The invention is not to be limited in scope by the following specific embodiment(s). This detailed description is intended for the purpose of exemplification only. Functionally equivalent products, compositions and methods are within the scope of the invention as described herein. Consistent with this position, those skilled in the art will appreciate that the invention described herein is susceptible to variations and modifications other than those specifically described. It is to be understood that the invention includes all such variations and modifications. The invention also includes all of the steps, features, compositions and compounds referred to or indicated in the specification, individually or collectively and any and all combinations or any two or more of the steps or features.

Further features of the invention are more fully described in the examples herein. It is to be understood, however, that this detailed description is included solely for the purposes of exemplifying the present invention, and should not be understood in any way as a restriction on the broad description of the invention as set out herein.

The entire disclosures of all publications (including patents, patent applications, journal articles, laboratory manuals, books, or other documents) cited herein are hereby incorporated by reference. No admission is made that any of the references constitute prior art or are part of the common general knowledge of those working in the field to which this invention relates.

Throughout this specification, unless the context requires otherwise, the word “comprise”, or variations such as “comprises” or “comprising”, will be understood to imply the inclusion of a stated integer or group of integers but not the exclusion of any other integer or group of integers.

Furthermore, throughout this specification, unless the context requires otherwise, the word “include”, or variations such as “includes” or “including”, will be understood to imply the inclusion of a stated integer or group of integers but not the exclusion of any other integer or group of integers.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

The invention described herein may include one or more range of values (for example, size, displacement and field strength etc.). A range of values will be understood to include all values within the range, including the values defining the range, and values adjacent to the range that lead to the same or substantially the same outcome as the values immediately adjacent to that value which defines the boundary to the range. For example, a person skilled in the field will understand that a 10% variation in upper or lower limits of a range can be totally appropriate and is encompassed by the invention. More particularly, the variation in upper or lower limits of a range will be 5% or as is commonly recognised in the art, whichever is greater.

Throughout this specification relative language such as the words ‘about’ and ‘approximately’ are used. This language seeks to incorporate at least 10% variability to the specified number or range. That variability may be plus 10% or negative 10% of the particular number specified.

In the drawings, like features have been referenced with like reference numbers.

As mentioned above, in this disclosure, a product embodying the invention and provided under the trade mark Beepit™ refers to a system 100 comprising a customer preference data collection centre and a customer offering optimisation centre that receives and processes Phase 1, Phase 2 and Phase 3 data as well as other data wherein the output of electronically generated advertisements and/or offers can provide improved take-up results. As discussed above, while the Beepit™ product is a useful model in this description in no way is the description of the Beepit™ product meant as a limitation to the scope of the invention. The Beepit™ product or other products embodying the invention can provide a delivery of recommendations or offers that are relevant to particular customers. The system 100 can have, for example, a website front-end and a backend database associated with it. In another embodiment, its front-end can comprise an application for a mobile device. The front-end is not limiting, as it comprises the output of electronically generated offers generated from obtained and processed data. In one embodiment, a plurality of offer vendors provide their offers to an offer library, the offers of which are accessed according to scores and other criteria relevant to particular customers. The offers, when decided by operation of the system 100 that they fit within certain parameters of a customer's likelihood to take-up the offers, are then delivered to a device of the customer by operation of the system 100.

The system 100 comprises a plurality of components, subsystems, and/or modules operably coupled via appropriate circuitry and connections to enable the system 100 to perform the functions and operations herein described. The system 100 comprises suitable components necessary to receive, store and execute appropriate computer instructions to carry out embodiments of methods in accordance with aspects of the invention.

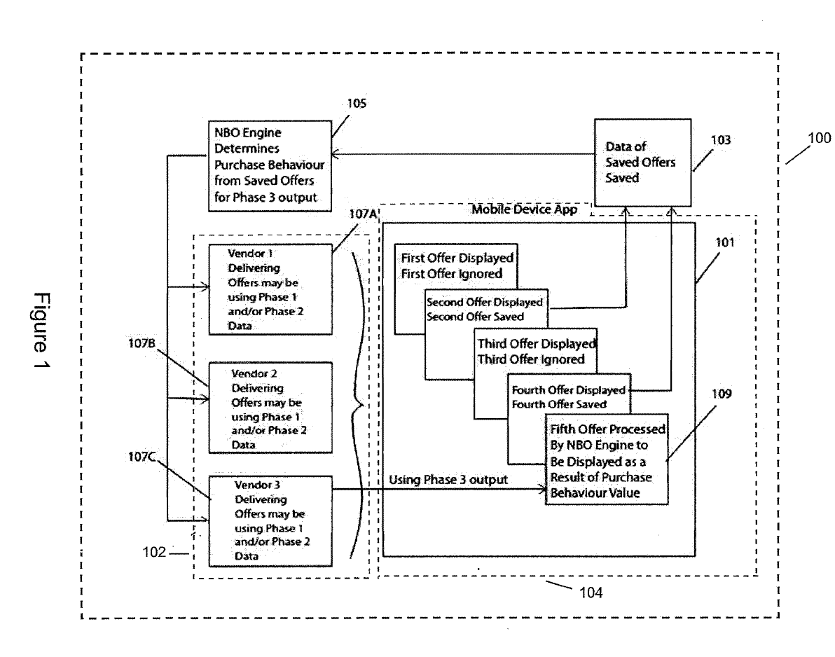

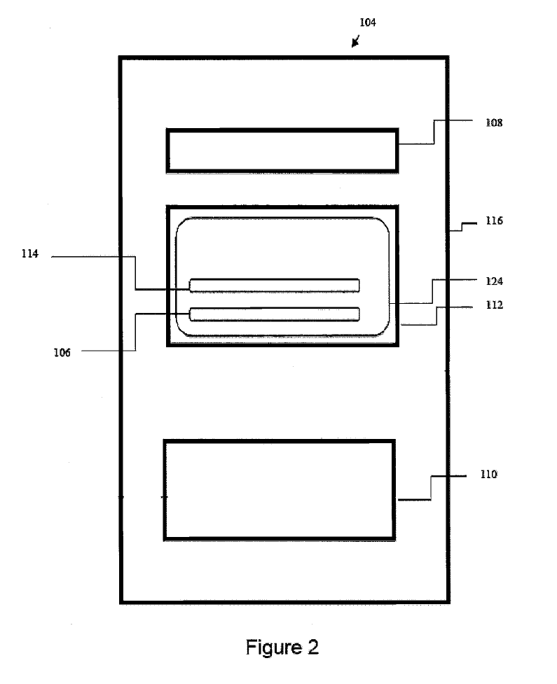

In the embodiment described the system 100 comprises, as depicted in FIG. 1, a mobile device application 101 which has access to a back-end offer library 102. The offer library 102 may be populated by one or more offer vendors 107. The number of offer vendors 107 is not limiting. Three offer vendors, respectively 107A, 107B, and 107C, illustrated in FIG. 1 are meant as an example. In the embodiment of FIG. 1, via the mobile application 101, offers can be pushed to a device 104 (depicted in further detail in FIG. 2) of a customer and the customer can indicate interest in the offers via a user interface 106 of the device 104. In this way, customer behaviours in the form of customer preference or behaviour data 103, referred to herein as Phase 3 data, can be collected, saved and processed by the system 100 to provide offers via the device user interface 106 in accordance with those customer behaviours.

Similar to the system 100, the device 104 comprises a plurality of components, subsystems and/or modules operably coupled via appropriate circuitry and connections to enable the device 104 to perform the functions and operations herein described. The device 104 comprises suitable components necessary to receive, store and execute appropriate computer instructions to carry out embodiments of methods in accordance with aspects of the invention, including the mobile device application 101.

Particularly, and as depicted in FIG. 2, the device 104 comprises computing means which in this embodiment comprises a controller 108 and storage 110 for storing electronic program instructions (such as the application 101) for controlling the controller 108, and information and/or data; a display 112 comprising a display screen for displaying the user interface 106; and input means 114; all housed within a container or housing 116.

The controller 108 is operable, under control of the electronic program instructions, to facilitate the performance via the device 104 of operations as described herein.

The controller 108 comprises processing means in the form of a processor.

The storage 110 comprises read only memory (ROM) and random access memory (RAM).

The device 104 is capable of receiving instructions that may be held in the ROM or RAM and may be executed by the processor. The processor is operable to perform actions under control of electronic program instructions, as will be described in further detail below, including processing/executing instructions and managing the flow of data and information through the device 104.

In preferred embodiments of the invention, the device 104 is a mobile device and comprises a smartphone such as that marketed under the trade mark IPHONE™ by Apple Inc, or by other provider such as Nokia Corporation, or Samsung Group, having Android, WEBOS, Windows, or other Phone app platform. Alternatively, the device 104 may comprise other computing means such as a personal, notebook or tablet computer such as that marketed under the trade mark IPAD™ or IPOD TOUCH™ by Apple Inc, or by other provider such as Hewlett-Packard Company, or Dell, Inc, for example, or other suitable device. In embodiments of the invention, the device 104 need not be a mobile device.

The device 104 also includes an operating system which is capable of issuing commands and is arranged to interact with the electronic program instructions to cause the device 104 to carry out the respective steps, functions and/or procedures in accordance with the embodiment of the invention described herein. The operating system may be appropriate for the device. For example, in the case where the device 12 comprises an IPHONE™ smartphone, the operating system may be iOS.

The device 104 is operable to communicate via one or more communications link(s), which may variously connect to one or more remote devices, such as the back-end offer library 102 of the system 100, as well as servers, personal computers, terminals, wireless or handheld computing devices, landline communication devices, or mobile communication devices such as a mobile (cell) telephone. At least one of a plurality of communications link(s) may be connected to an external computing network through a telecommunications network.

The back-end offer library 102 comprises a computing system having the form of a server in the embodiment. The server may be used to execute application and/or system services to carry out embodiments of methods in accordance with aspects of the invention.

In the embodiment, the server is physically located at a centrally managed administration centre. In alternative embodiments, it may be held on a cloud based platform.

Similar to the system 100 and the device 104, the server comprises suitable components necessary to receive, store and execute appropriate electronic program instructions. The components include processing means in the form of a server processor, server storage comprising read only memory (ROM) and random access memory (RAM), one or more server input/output devices such as disc drives, and an associated server user interface. Remote communications devices (including the device 104) are arranged to communicate with the server via the one or more communications link(s).

The server is capable of receiving instructions that may be held in ROM, RAM or disc drives and may be executed by the server processor. The server processor is operable to perform actions under control of electronic program instructions, as will be described in further detail below, including processing/executing instructions and managing the flow of data and information through its respective computing system.

The server includes a server operating system which is capable of issuing commands to access at least one database or databank which resides on the storage device thereof. In the embodiment, the at least one database comprises the offer library 102. The operating system is arranged to interact with the offer library 102 and with one or more computer programs of a set/suite of server software to cause the server to carry out the respective steps, functions and/or procedures in accordance with the embodiment of the invention described herein. In embodiments of the invention, any suitable database structure may be used, and there may be more than one database.

The electronic program instructions for the computing components of the system 100, the device 104, and the offer library 102 can be written in any suitable language, as are well known to persons skilled in the art. In embodiments of the invention, the electronic program instructions may be provided as software as stand-alone application(s), as a set or plurality of applications, via a network, or added as middleware, depending on the requirements of the implementation or embodiment.

In alternative embodiments of the invention, the software may comprise one or more modules, and may be implemented in hardware. In such a case, for example, the modules may be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA) and the like.

The respective computing means can be a system of any suitable type, including: a programmable logic controller (PLC); digital signal processor (DSP); microcontroller; personal, notebook or tablet computer, or dedicated servers or networked servers.

The respective processors can be any custom made or commercially available processor, a central processing unit (CPU), a data signal processor (DSP) or an auxiliary processor among several processors associated with the computing means. In embodiments of the invention, the processing means may be a semiconductor based microprocessor (in the form of a microchip) or a macroprocessor, for example.

In embodiments of the invention, the respective storage can include any one or combination of volatile memory elements (e.g., random access memory (RAM) such as dynamic random access memory (DRAM), static random access memory (SRAM)) and non-volatile memory elements (e.g., read only memory (ROM), erasable programmable read only memory (EPROM), electronically erasable programmable read only memory (EEPROM), programmable read only memory (PROM), tape, compact disc read only memory (CD-ROM), etc.). The respective storage may incorporate electronic, magnetic, optical and/or other types of storage media. Furthermore, the respective storage can have a distributed architecture, where various components are situated remote from one another, but can be accessed by the processing means. For example, the ROM may store various instructions, programs, software, or applications to be executed by the processing means to control the operation of the device 104 and the RAM may temporarily store variables or results of the operations.

The use and operation of computers using software applications is well-known to persons skilled in the art and need not be described in any further detail herein except as is relevant to the invention.

Furthermore, any suitable communication protocol can be used to facilitate connection and communication between any subsystems or components of the system 100, any subsystems or components of the device 104, any subsystems or components of the server, and the system 100, the device 104 and the server and other devices or systems, including wired and wireless, as are well known to persons skilled in the art and need not be described in any further detail herein except as is relevant to the invention.

Where the words “store”, “hold” and “save” or similar words are used in the context of the invention, they are to be understood as including reference to the retaining or holding of data or information both permanently and/or temporarily in the storage means, device or medium for later retrieval, and momentarily or instantaneously, for example as part of a processing operation being performed.

Additionally, where the terms “system”, “device”, and “machine” are used in the context of the invention, they are to be understood as including reference to any group of functionally related or interacting, interrelated, interdependent or associated components or elements that may be located in proximity to, separate from, integrated with, or discrete from, each other.

Furthermore, in embodiments of the invention, the word “determining” is understood to include receiving or accessing the relevant data or information.

In the embodiment of the invention, the display 112 for displaying the user interface 106 and a user input means are integrated in a touchscreen 124. In alternative embodiments these components may be provided as discrete elements or items.

The touchscreen 124 is operable to sense or detect the presence and location of a touch within a display area of the device 104. Sensed “touchings” of the touchscreen 124 are inputted to the device 104 as commands or instructions and communicated to the controller 108. It should be appreciated that the user input means is not limited to comprising a touchscreen, and in alternative embodiments of the invention any appropriate device, system or machine for receiving input, commands or instructions and providing for controlled interaction may be used, including, for example, a keypad or keyboard, a pointing device, or composite device, and systems comprising voice activation, voice and/or thought control, and/or holographic/projected imaging.

The reason that the embodiment of FIG. 1 is depicted first is to provide the reader with an understanding that the data collected for Phase 3 can occur in any number of manners. In this example embodiment, collection of the Phase 3 data occurs in nearly real time. On the other hand, Phase 3 data may be stored as it may have been received during sales to customers, which may be available, for example to big retails such as grocery chains. The manner in which the data of Phase 3 is collected is not limited by whether it is received in real time or stored, for example, via an application, website, or a “bricks and mortar” distribution channel.

In the example of FIG. 1, prior to receiving enough customer preference or behaviour data of Phase 3, offers are generated in accordance with Phase 1 and/or Phase 2 data. Once enough customer preference or behaviour data is obtained, as mentioned above, an NBO Engine 105, described in detail below, determines in accordance with Phase 3 purchase behaviours and provides such information to at least one offer vendor 107 so that the offer vendor can deliver offers or make recommendations based upon, among other factors, customer behaviours 109. Vendors 1, 2 and/or 3 can provide offers or aggregate across the retailers as to what they sell such for example, stored in the offer library 102. An offer library may be updated in real time as well, for example, in accordance with the information provided by Phase 3 data. In this way, because purchase behaviour data is obtained and processed, a user of the mobile application depicted in FIG. 1 can receive offers more relevant to that user and therefore the take-up results may be improved.

The particular interface of FIG. 1 can provide a method of a mobile device application comprising displaying a first received electronic offer on the display screen of the mobile device, receiving a first input representing an action relating to the first electronic offer from the display screen, replacing the first electronic offer on the display screen by a second received electronic offer on the display screen in accordance with the first input, displaying the second received electronic offer on the display screen, receiving a second input representing an action relating to the second electronic offer from the display screen, generating a save process to generate a saved electronic offer in accordance with the second input and transmitting data related to the saved electronic offer. The first input can be, for example, in the form of a swipe of the screen in a first direction. The second input can be, for example, in the form of a swipe of the screen in a direction different than the first direction, that being a second direction.

Furthermore, the methods and systems described can provide that the application is in communication with data processing capabilities, for example, remotely, that can receive one or more saved electronic offers.

An engine can obtain a purchase behaviour data and process the same to generate a purchase behavioural value. A purchase behaviour value comprises a dynamically calibrated score or measure determined by characterisation of data collected related to a plurality of received saved electronic offers. Thus the described methods and systems can further provide generating a third electronic offer 109 for display in accordance with the obtained Purchase Behaviour Value.

As mentioned above, any number of products can embody the described systems and methods. FIG. 1 illustrates a mobile application. Also described is the product provided under the trade mark Beepit™. The Beepit™ product, as one product that can embody the described methods and systems, can be useful for combining a plurality of offer libraries of different offer vendors so that customers can receive optimized customer offering from more than one offer vendor. Products can be utilized by different types of organizations, for example, B2B and/or specific industries. Moreover, contemplated is non-commercial endeavours such as systems for alerts of any type. The embodiments described herein are not intended to limit the scope of the description. To deploy the NBO Optimisation Engine across different organisations and industries may require customer data inputs to be designed and transformed in a certain way and for Offer Attributes against Offers to also be defined in a certain way.

As mentioned above, vendors can deliver offers or make recommendations based upon Phase 1 and Phase 2 data prior to utilising Phase 3 data and then in combination with Phase 3 data. Phase 1 can be obtained directly from a customer or someone associated with the customer. Phase 1 data collection can include a framework behind how a customer manages their preferences and provides information (e.g. interests and likes as well as their communication channel preferences). Via a product, such as that provided under the trade mark Beepit™, which may collect Phase 1 data, individuals can:

1. register themselves (i.e. become a ‘member’) and their ‘characters’ (i.e. their friends, family members etc.);

2. register their and their ‘characters’ (standard) attributes (e.g. age, gender; see below), and preferences on (standard) product attributes;

3. browse products and click to redirect to the retailer's product website, in order to buy the product;

4. set-up events for specific ‘characters’ on calendar, and instruct Beepit™ to automatically send a reminder for the event, at a pre-specified number of days (such as, for example, 1 to 14 days) before the event; and

5. in the reminders, members can be redirected, for example, to a retailer's product website.

Retailers can:

1. Join the Beepit™ system and register their products, that is, populate an offer library onto the Beepit™ system website or platform, for individuals to browse, and for the Beepit™ system to put as recommended products into any delivery channel for reminders.

The Beepit™ system of the embodiment is operable to:

1. Automatically record the attributes of members and their ‘characters’, and product attributes registered by retailers; and automatically update them whenever there is an update from members or retailers.

2. Automatically generate and send a reminder to individuals (at the individual-specified day before specific event), which contains recommendation of products that are deemed to be most suitable to the ‘character’.

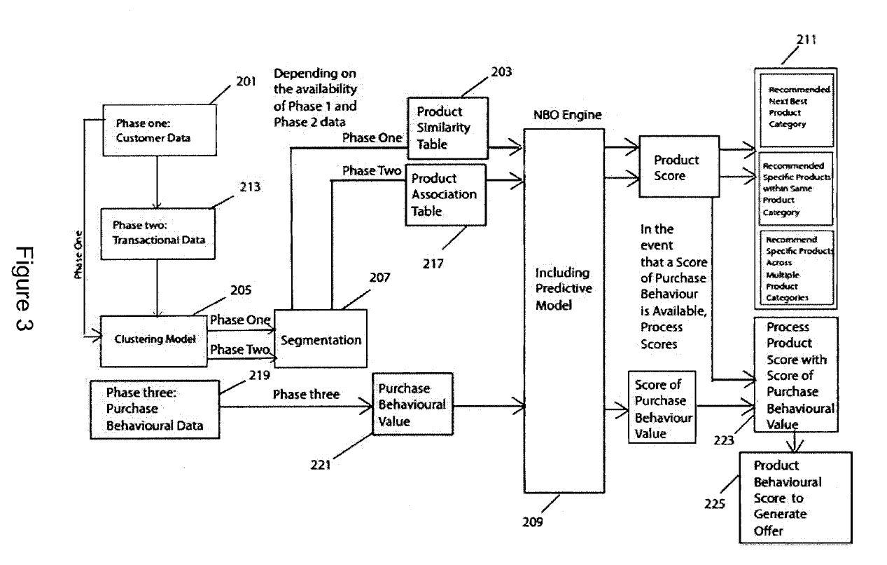

Accordingly, to obtain Phase 1 data, a registration page or application may provide a customer or potential customer the opportunity to define themselves. As shown in FIGS. 2 and 3, that information can be used in a Phase 1 generation of offers, and/or in combination with a Phase 2 generation of offers, and/or in combination with a Phase 3 generation of offers.

Even though it may be a specific website or application designed with a specific purpose, the framework of Phase 1 is behind how a customer manages their preferences and can provide information (e.g. interests and likes as well as their communication channel preferences) which can be used by any organisation to which that customer is affiliated (as long as the customer has consented) and/or be utilised by a particular organisation/brand to collect additional information about the customer that is specific to their business. An organisation is enabled to create an “omnichannel” experience to their customer (where customer preference data can be used universally across brands) and may be an important component of being able to scale the deployment of the NBO Optimisation Engine. That is, with reference to FIG. 1, where there are more than one offer vendors, a described system and/or method can provide the ability to present customer offerings in an omnichannel manner.

Phase 1 data is one source of information that the Engine can use (if available) to score each offer for each customer. In Phase 2, transformed transactional data can be processed with Phase 1 scores. As more transactional data of Phase 2 is created, Phase 1 transformed data may be weighted with less importance to provide a Product Score, which can be processed with Phase 3's Purchase Behaviour Values. As illustrated in FIG. 3, the combination of Phase 1, Phase 2 and Phase 3 data, individually or in combination are inputs into a predictive model of the NBO (see FIG. 3) of a particular customer or customer segment can provide a decisioned offer based on the Product Score for electronic delivery to a customer.

Referring to FIGS. 1, 3 and 4, it should be here pointed out that technical papers to be used in the making of products have been prepared which describe in detail embodiments of the methods and systems and are provided in full below. Those technical papers, while not written as a patent specification, provide substantial information to assist those skilled in the art in carrying out the present invention. In the interest of full disclosure and providing those skilled in the art the best way that the applicant knows how to carry out the present invention at the time of filing, those technical papers are provided herein. Hence, the use of terms such as “are required”, “should”, “must” and the like are not to be taken literally in the context of this disclosure as the technical papers were prepared by the inventors who are not skilled patent attorneys. That is, the inventors are not skilled in preparing patent applications. To those skilled in the art, where adjustments can be made to the teachings described herein, it is expected that they will be made. Moreover, the term “algorithm” may be used loosely by the inventors in their description. It is understood that algorithms are involved in carrying out the present invention. However, the present invention is not an algorithm. It is systems and method for receiving electronic data of varying forms, carrying out processes on that data under particular circumstances so that that it is manipulated in a manner so that it can be used to decide which electronically generated customer offering to deliver to customers and/or potential customers for an improved take-up result. The technical problems solved by embodiments of the invention in delivering relevant electronically generated advertisements and/or offers in accordance with this disclosure provide for the avoidance of wasted resources. It is in the interest of time in a commercial context that those technical papers are part of this disclosure as they were prepared by the inventors. FIGS. 1, 3 and 4 provide high-level overviews of the described methods and systems. In fact, as will be evident to those skilled in the art from this disclosure, there are many different facets to the present description that individually and collectively may be distinguished from one another and therefore can be claimed as such.

FIG. 3 depicts data of Phase 1, Phase 2 and Phase 3 resulting in a product behavioural score 225 to generate a decisioned offer to a particular customer or customers. Also depicted is that the different data processes can be utilized separately or as a plurality of inputs to the overall modeling process which results in generating an electronic offer for delivery to a customer.

The following illustration provides the data type by phases and describes some examples of variables (but not limited to) in each data type which may or may not be included in embodiments of the invention:

The following section provides examples of using Phase 1, 2 and 3 to illustrate the Product Score and Product Behavioural Score to provide a Decisioned Offer. Note, for simplicity the examples below use a sum of values to illustrate what the “Leaning & Scoring Engine” that would include a prediction model may do. A sum is however, an example of a process that may be carried out on the scores generated from Phase 1, 2 and 3 data. Utilizing the term sum is not intended to have a limiting meaning. Additional and/or alternative processes are included within the scope of the present invention.

Granted we have 2 offers in the offer library, Coffee and Branded Detergent with the following predetermined target audience and products attributes:

Offer Library

| | Coffee | Branded Detergent |
|---|---|---|
| Target Audience | Customers aged in | Families with Kids, |
| | 25-30 | Individuals who enjoy |
| | | green products |
| Key Product Attributes | Organic | New Product, Eco |
| | | Friendly |

Assuming Customer A has provided the customer data and preference data below:
Age=31
Status=Married with kids
Interest=Always Eco Friendly

The following Table 1 shows the product score using the Customer data and Preference data to determine the recommended offer based on the key attributes of the products.

TABLE 1

| | Coffee | Branded Detergent |
|---|---|---|
| Score using Phase 1 | Aged 31 = 0.2 | Family with Kids = 0.2 |
| Data | | Eco Friendly = 0.3 |
| Product Score | Total = 0.2 | Total = 0.5 |

Product Score for coffee is relatively low (total=0.2) using Phase 1 data because we only able to relate one customer data (age) to the offer attribute. On the other hand, customer A is more likely to take-up Branded Detergent because the customer data and preference data match the offer attribute.

Assuming the following transaction data and response data for Customer A is extracted into the engine:
Purchased coffee machine in the last 3 months and last coffee purchase in 12 days ago.
Purchase cycle for coffee is 14 days.
Did not respond to previous detergent offer.

Table 2 provides an example of how the Phase 2 takes into account of what customers has purchased in the past and how they responded to previous offers.

TABLE 2

| | | |
|---|---|---|
| Product Score | Coffee = 0.2 | Branded |
| using Phase 1 | | Detergent = 0.5 |
| Score using | Purchase closely- | Did not responded to |
| Phase 2 Data | related items = 0.1 | previous detergent |
| | Within Coffee | offer = −0.1 |
| | Purchase Cycle = 0.2 | |
| Product Score | Total = 0.5 | Total = 0.4 |
| using Phase | | |
| 1 and 2 | | |

While the Product Score using Phase 1 data inputs only is higher for Branded Detergent for this customer, when considering Phase 2 transactional data and response data, the coffee offer is more likely to receive take-up.

Assuming Customer A has the following purchase behaviour attributes:
Have regular transactions with organic food.
Higher tendency to respond to recommendations with offer points

The following Table 3 provides an example of how the product score provides a Decisioned Offer based on Phase 1 and Phase 2 (transformed) data that is different to a version that includes the Purchase Behaviour value (Phase 3 data).

TABLE 3

| | | |
|---|---|---|
| Product Score | Coffee = 0.5 | Branded Detergent = 0.4 |
| Score using Purchase | Organic = 0.1 (or | Points = 0.25 (or |
| Behavioural Values | Points or | Discounts or New |
| | Discounts) | product) |
| Product Behavioural | Total = 0.6 | Total = 0.65 |
| Score | | |

Accordingly, while the Product Score using Phase 1 and Phase 2 inputs only is higher for coffee for this particular customer, when factoring in the Purchase Behaviour Value 462 (Phase 3 Input to the predictive model generating a score of the purchase behaviour value 232), the coffee offer is less likely to receive take-up as would be for the Branded Detergent.

Again referring to FIG. 3, Phase 1 data 201 includes information provided by a customer (and other data, for example, demographic information), such as particular likes which can be referred to as customer data. In the first instance, the customer profile provided by a customer can provide data that can distinguish customers. For example, a display device may provide a user interface that allows a customer to register their particular likes. For example, that customer may like books, photography and clothing. Therefore, as an individual, a customer may create a character for themselves, or for any one else such as their spouse, children, siblings, parents and others. In the first instance Phase 1 utilizes the character provided by the customer to make offers to the customer based on that information. In the process of utilizing the character of the customer data that is provided by the customer, the process and system can access a similarity value in one or more lookup tables which include scores. For example, a product association lookup table may include an association of “a like” of photography with “a like” of art.

Accordingly, Phase 1 data 201 and Phase 2 data 213 may be processed by a Clustering Model and/or may then be subjected to Segmentation 207. Phase 2 data is collected Transactional Data 213. As mentioned above, as more transactional data of Phase 2 is created, Phase 1 transformed data may be weighted with less importance to provide a Product Score 230 Phase 1 can be utilized when there is insufficient behavioural data related to the customer or in combination with transactional data. Phase 1, in actuality, may be of a short time use as the transaction data explained in more detail below, may be a better manner in which to predict which offers will receive higher take-up results. In phase 2, depending on whether there is substantial transaction data, separate NBO processes may be designed for each case.

Product association is a term in the digital marketing sector. However, in the context here, the product association is provided in a unique manner. Loosely speaking, a Product Association Table 217 is a set of statistical probabilities that a customer or type of customer will purchase a particular product. The product association table, in combination with computations involving transaction data can provide what is referred to in this document as a Product Score 230.

The scores of the Product Association Table 217 may work in the following manner. For example, were a customer in the age group of 30-40 and a particular offer targets 30-50, then that would be a 100% correlation. However, were the customer of an age of 29, then there is still a closeness to 30-50, so the score can reflect how close the customer is to the target attribute. That process can be carried out for some or all of the customer attributes. In this way there is a notion of similarity as well as the notion of weight. The discussion below describes how the weights are monitored and adjusted. The scores and weights can be dynamically adjusted with automatic and/or manual intervention so as to optimize the process.

Transaction Data 213 of Phase 2 takes into account what a customer has purchased but does not necessarily take into account purchase behaviour of a particular customer which is related to Phase 3, Purchase Behaviour Data 219. Referring to Phase 1 and Phase 2 data, processes such as the application of a clustering model 205 and/or segmentation 207 can occur. Ultimately, from Phase 1 data, a product similarity table 203 can result, and from Phase 2 data, a Product Association Table 217 can result. Each of these may be subjected to the NBO Engine 209, that is the “Learning and Scoring Engine” to generate a Product Score 230 which results in electronically generated offer output 211.

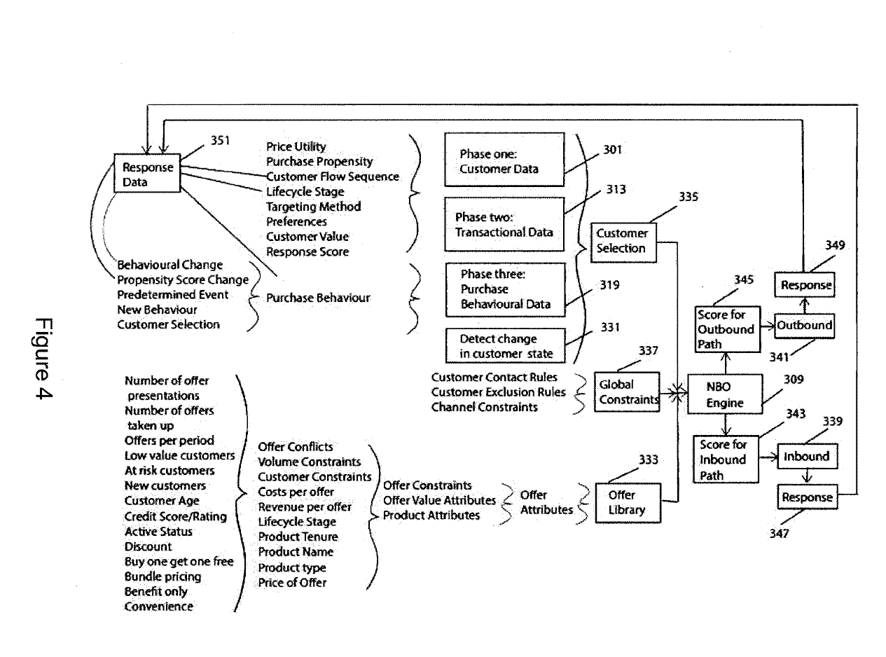

In the context of the described methods and systems there are several processes through which decisions are made prior to an offer or recommendation being electronically generated for delivery to a customer, either in an inbound manner or an outbound manner which is illustrated in FIG. 4. An offer, notice, recommendation or any other type of electronically generated information for delivery to an electronic device is referred herein as an offer.

Further data types not shown in FIG. 3, for example, Transformed Transaction Data takes into account individual customer data transaction and/or customer segmentation wherein there is a mapping between the purchases one customer has made to the expected purchases of another customer in the same customer segment. Taking into account the transformed customer data with the transformed transaction data, the Product Association Probabilities table can be obtained. The predictive model combining the transformed data can result in a Product Score 230 that may be used to generate an offer to a customer 211. It is expected that higher take-up results will occur when the Product Score 230 is used to generate an offer to a customer. It is useful, prior to the utilization of the Purchase Behaviour Values 221 comprising a calibrated score determined by characterisation of data collected of the purchasing conduct of a customer (Transaction Data and Response Date) to utilize customer profile data and preference of Phase 1 and also in combination with the Phase 2 Data which provides a Product Score 230. As will be discussed in more detail below, the transformed data using Phase 1, Phase 2 and Phase 3 inputs is expected to generate one or more Decisioned Offers for delivery to a customer or a plurality of customers' higher take-up results than previously realized, as is discussed below.

FIG. 4 depicts data types that can make up Phase 1 data 301, Phase 2 data 313 and Phase 3 data 319 as well as the ability to detect a change in customer data 331. As mentioned above, calibration and weighting can be an ongoing process in utilizing the collected data. Separately, an Offer Library 333 exists. Output of the combination Customer Selection 335, Global Constraints 337 and the Offer Library 333 will undergo processing by the NBO Engine 309.

There are inbound initiation of offers 339 and outbound initiation of offers 341 depending upon whether the score achieved is below a score 343 or above a score 345. A customer, user or recipient via the device 104 can receive an offer. When a customer accesses a website or application that is considered an inbound initiation. When a vendor or vendor agent initiates the communication with a customer that is an outbound initiation. In the described scoring methods and systems, the scores will be relevant for inbound or outbound and can determine whether an offer is to be inbound or outbound for a particular customer. For an inbound channel, the customer initiates the communication. An outbound vendor initiates the conversation with the customer. Registering is like an outbound initiation as the customer can provide the system information when the customer will want to receive communication, i.e., an anniversary or birthday.

Again referring to FIG. 1, a response 347 or 349 can be made by for example, saving an offer to provide data of saved offers 103. In another embodiment, by browsing in a website and clicking through, response data 351 can be collected. From the response data, processes can include dynamic calibrations and weighting. It is understood that the present system and methods provide for dynamically managed output.

As discussed above, following are technical papers prepared by the inventors in preparing a product embodying the present invention. Some of the terminology provided above may be different to that provided below as the documents were prepared for different purposes. The concepts are the same.

The instant disclosure is provided to explain in an enabling fashion the best modes of making and using various embodiments in accordance with aspects of the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

Modifications and variations such as would be apparent to a skilled addressee are deemed to be within the scope of the present invention.

1. (canceled)

2. A method, comprising:
storing data that is representative of a plurality of offers associated with a plurality of respective offer vendors and being associated with product scores comprising probabilities that a particular user will obtain a first product;
calculating a behavioral value and a score of the behavioral value relating to the particular user, the score of the behavioral value being calculated as a calibrated score determined by a characterization of data indicative of conduct of the particular user;
mathematically combining the product score with the score of the behavioral value to generate a first product behavioral score;
mathematically combining the first product behavioral score with a similarly derived second product behavioral score; and
generating, for delivery to the particular user, a first offer or a second offer based upon the first product behavioral score and the second product behavioral score.

3. The method according to claim 2, further comprising:
obtaining a second behavioral value and generating a score of a second behavioral value for a second particular user,
wherein a characterization of data associated with the first particular user is distinguishable from a characterization of data associated with the second particular user.

4. The method according to claim 2, further comprising:
transmitting one of the first offer or the second offer via at least one of an email, a website, a mobile application, a text message, and a voice message.

5-6. (canceled)

7. The method according to claim 2, further comprising:
transmitting one of the first offer and the second offer within a predetermined time frame.

8. The method according to claim 2, further comprising:
prior to generating the second offer, determining whether generating either the first offer or the second offer violates a rule associated with the first offer or the second offer.

9. (canceled)

10. The method according to claim 2, wherein the first product behavioral score and the second product behavioral score are weighted.

11. The method according to claim 2, wherein the conduct includes a monetary value of historical purchases.

12. The method according to claim 2, wherein the first particular user is one of an individual customer and a member of a customer segment.

13. The method according to claim 2, wherein the score of the behavioral value is dynamically calibrated.

14. A system, comprising:
a backend server configured to:
store data that is representative of a plurality of offers associated with a plurality of respective offer vendors and being associated with product scores comprising probabilities that a particular user will obtain a first product;
calculate a behavioral value and a score of the behavioral value relating to the particular user, the score of the behavioral value being calculated as a calibrated score determined by a characterization of data indicative of conduct of the particular user;
mathematically combine the product score with the score of the behavioral value to generate a first product behavioral score;
mathematically combine the first product behavioral score with a similarly derived second product behavioral score; and
generate, for delivery to the particular user, a first offer and a second offer based upon the first product behavioral score and the second product behavioral score; and
a mobile computing device configured to:
display the first offer once the first offer is received from the backend server;
save the first received offer to memory and replace the displayed first received offer with the second received offer in response to receiving a first input representing an action relating to the first offer;
receive a second input representing an action relating to the second offer;
save the second offer to memory in response to receiving a second input representing an action relating to the second offer when the second input is associated with saving the offer; and
transmit data related to one or more of the first or the second saved offers.

15. The system according to claim 14, wherein the backend server is further configured to calculate the score of the behavioral value as a dynamically calibrated score, which is determined by a characterization of data related to one or more of the first or the second offers.

16. The system according to claim 14, wherein the backend server is further configured to generate a third offer for display on the mobile computing device.

17-19. (canceled)

20. The system according to claim 14, wherein the mobile computing device is further configured to, when (i) the first input is not an action relating to saving the first offer, and (ii) the second input is not an action relating to saving the second offer, replacing the first offer or second offer, respectively, on the display with a third offer received from the backend server.

21. The system according to claim 14, wherein the backend server is further configured to transmit one of the first offer and the second offer within a predetermined time frame.

22-29. (canceled)

30. A non-transitory, tangible computer-readable medium storing machine readable instructions that, when executed by a processor, cause the processor to:
store data that is representative of a plurality of offers associated with a plurality of respective offer vendors and being associated with product scores comprising probabilities that a particular user will obtain a first product;
calculate a behavioral value and a score of the behavioral value relating to the particular user, the score of the behavioral value being calculated as a calibrated score determined by a characterization of data indicative of conduct of the particular user;
mathematically combine the product score with the score of the behavioral value to generate a first product behavioral score;
mathematically combine the first product behavioral score with a similarly derived second product behavioral score;
generate, for delivery to the particular user, a first offer or a second offer based upon the first product behavioral score and the second product behavioral score.

31. The non-transitory, tangible computer-readable medium according to claim 30, further storing instructions that, when executed by the processor, cause the processor to:
obtain a second behavioral value and generate a score of a second behavioral value for a second particular user,
wherein a characterization of data associated with the first particular user is distinguishable from a characterization of data associated with the second particular user.

32. The non-transitory, tangible computer-readable medium according to claim 30, further storing instructions that, when executed by the processor, cause the processor to transmit one of the first offer or the second offer via at least one of an email, a website, a mobile application, a text message, and a voice message.

33. The non-transitory, tangible computer-readable medium according to claim 30, further storing instructions that, when executed by the processor, cause the processor to:
prior to generating the second offer, determine whether generating either the first offer or the second offer violates a rule associated with the first offer or the second offer.

34. The non-transitory, tangible computer-readable medium according to claim 30, further storing instructions that, when executed by the processor, cause the processor to weight the first product behavioral score and the second product behavioral score.

35. The non-transitory, tangible computer-readable medium according to claim 30, further storing instructions that, when executed by the processor, cause the processor to dynamically calibrate the score of the behavioral value.
